(19) United States
(12) Patent Application Publication
(10) Pub. No.: US 2023/0247951 A1
(43) Pub. Date: Aug. 10, 2023

(54) A DENDROBIUM WATERING METHOD AND SYSTEM

(71) Applicants: Guiyang PENG, Haikou City, Hainan (CN); HAINAN DENDROBIUM HEALTH INDUSTRY CO.,LTD., Haikou City, Hainan (CN)

(72) Inventors: Guiyang PENG, Haikou City, Hainan (CN); Wanxing ZHANG, Haikou City, Hainan (CN); Xiangming NING, Haikou City, Hainan (CN); Wu LI, Haikou City, Hainan (CN); Xiaoping CHEN, Haikou City, Hainan (CN); Haisong FU, Haikou City, Hainan (CN); Guobing WU, Haikou City, Hainan (CN); Wei DENG, Haikou City, Hainan (CN)

(21) Appl. No.: 17/624,280

(22) PCT Filed: Dec. 27, 2021
(86) PCT No.: PCT/CN2021/141700

§ 371 Date: Dec. 31, 2021

(30) Foreign Application Priority Data
Jan. 7, 2021 (CN) 202110019850.6

(51) Int. Cl. A01G 25/16; B05B 1/26

(52) U.S. Cl. CPC A01G 25/167; B05B 1/265

(57) ABSTRACT

This application provides a dendrobium watering method and system, by way of imitation of wild cultivation of dendrobium on volcano, first on the volcano cant selection from the top 15 to 25 cm line code position, use a hard masonry nail line code insert to spray rod fixed to the fixed position of the line of code. The ground lance G-shaped nozzle is higher than the top of the volcano.

### FIELD OF THE INVENTION

This application belongs to the technical field of plant watering,especially involving a dendrobium watering method and system.

### BACKGROUND OF THE INVENTION

Dendrobium (scientific name: dendrobium nobile Lindl) with upright stems, fleshy and slightly flat cylindrical shape, is 10-60 cm long and 1.3 cm thick. Dendrobium likes to grow in a warm, humid, semi-cloudy and semi-sunny environment. It is better to grow in subtropical deep mountain forests with annual rainfall of more than 1000 mm, air humidity of more than 80% and average temperature of more than 8° C. in January. The requirements for soil and fertilizer are not strict. Wild plants mostly grow on loose and thick bark or trunk, and some also grow in crevices.

Planting Dendrobium by imitating the wild way, first, it has good quality, and it is nourished by clouds, fog, rain and dew all the year round, and the quality of Dendrobium candidum produced is the same as that of the wild one; Second, the yield is high, and the number of Dendrobium planted per unit area can be greatly increased through artificial seedling raising;Third, the cost is low, imitation wild cultivation does not need greenhouse and other equipment investment, imitation wild way of planting dendrobium is one of the key links of dendrobium watering.

In the existing technology, a water pipe frame is installed above the dendrobium, and the sprinkler head is installed to water the dendrobium directly. However, in the planting environment of imitation wild way, it is not easy to install the water pipe frame, and with the growth of dendrobium, it is necessary to constantly adjust the height of the water pipe frame, and the operation is tedious. When sprinkler head irrigates dendrobium directly, the water pressure of sprinkler head should be adjusted all the time to avoid damage to dendrobium caused by water impulse.

### SUMMARY OF THE INVENTION

This application provides a dendrobium watering method and system to solve the existing dendrobium watering method in the water pipe frame installation is not easy, and need to constantly adjust the height of the water pipe frame, cumbersome operation, at the same time need to always adjust the water pressure of the nozzle, to avoid water momentum damage to dendrobium technical problems.

In view of this, this application provides a dendrobium watering method, which includes selecting the position of fixed line code 15-25 cm away from the top on the slope of volcanic rock.

The line code with hard cement nails was used to fix the ground jet rod at the fixed line code position. The G-shaped nozzle of the ground jet rod was higher than the top of the volcanic stone, and the ground jet rod was connected to the reservoir through a booster pump.

The pressure of the booster pump was controlled to increase to 2-5 kpa, so that the G-shaped nozzle of the ground injection rod sprayed circular water mist to water dendrobium on the volcanic stone

Optionally, the position of the fixed line code is 20 cm above the volcanic rock slope.

Optionally, the pressure of the booster pump was controlled to increase to 2-5 kpa, so that the G-shaped nozzle of the ground injection rod sprayed circular water mist to irrigate dendrobium on the volcanic stone, including: When the humidity in the hemispherical area with a radius of 1 m and a volcanic stone as the center was lower than the preset threshold, the pressure of the control booster pump was increased to 2-5 kpa, so that the G-shaped nozzle of the ground injection rod sprayed circular water mist and watered the Dendrobium on the volcanic stone.

Optionally, the pressure of the booster pump was controlled to increase to 2-5 kpa, so that the G-shaped nozzle of the ground injection rod sprayed circular water mist to irrigate dendrobium on the volcanic stone, including: in a volcano as the center of the circle, the hemisphere of radius of 1 m area when the humidity is lower than the preset threshold, according to a preset amount of moisture and water table to determine target spraying quantity, control booster pump water pressure increase to 2-5 kpa makes ground lance G-shaped of nozzle jet circle water mist, spray rod is inserted in to the actual amount reach the target amount of spray water, control the pump stop working.

Optionally, the G-shaped nozzle includes a nozzle, refractor nozzle and bracket. The refracting nozzle is installed directly above the nozzle through the support. After the pressure of the booster pump is increased to 2-5 kpa, the water column of high velocity is sprayed through the nozzle, and the water column is scattered on the refracting nozzle to form a circle of water mist.

Optionally, the ground spray rod is fixed to the fixed line code position using a line code with hard cement nails, including: use a hammer drill to drill a small hole in the position of the fixed line code, put in the expansion colloidal particles, insert the ground jet rod into the line code jack, and then fix the line code on the expansion colloidal particles with screws.

The present invention also provides a dendrobium watering system including reservoir, the main water pipe, water pipe, pump, spray rod and controller, reservoir connecting the main water pipe, the main pipe, water pipe has a booster pump and water pump inlet connected to the reservoir, water pipe and pump outlet connection, water pipe connected to spray rod, pump connected to the controller

Optional, the ground insert spray rod includes insert rod, water distribution pipe, water distribution pipe joint, nozzle, refraction nozzle and bracket. The water distribution pipe joint is fixed on the top of the plug rod, and the plug rod is an inverted cone rod. The water distribution

pipe joint is provided with a connecting part and a water outlet part, the water distribution pipe is connected with the water outlet pipe joint through the connecting part, and the water outlet is connected with the connecting part. The nozzle is arranged on the top of the water outlet, connected to the water outlet, and the refraction nozzle is installed directly above the nozzle through the bracket.

Optionally, a filter layer is arranged between the connecting part and the outlet part.

Optionally, it also includes a humidity sensor, which is connected to the controller. The humidity sensor is used to detect the humidity in the 1-meter radius of the hemispheric area with a volcanic rock center and send humidity

The controller is used to control the increase of the pressure of the booster pump to 2-5 kpa, so that the G-shaped nozzle of the ground injection rod can spray circular water mist and water the dendrobium on the volcanic stone.

A dendrobium watering method is provided in this application, including: a fixed line code was selected 15-25 cm above the top of the volcanic rock slope.

The line code with hard cement nails was used to fix the ground jet rod at the fixed line code position. The G-shaped nozzle of the ground jet rod was higher than the top of the volcanic stone, and the ground jet rod was connected to the reservoir through a booster pump.

The pressure of the booster pump was controlled to increase to 2-5 kpa, so that the G-shaped nozzle of the ground injection rod sprayed circular water mist to water dendrobium on the volcanic stone.

The dendrobium watering method provided in this application adopts the imitation wild way to plant dendrobium on the volcanic stone. The position to fix the line code is selected in the upper part of the volcanic stone slope, and the position of the nozzle of the ground spray rod is kept higher than the top of the volcanic stone, so as to ensure that the water sprayed out at last fall evenly on the whole volcanic stone. With hard cement nails will be fixed in the line code on the volcanic stone, and then the ground insert spray rod inserted into the line code jack for fixing, to avoid in the pouring process of ground insert spray rod shaking and falling on the ground, can’t continue to irrigate the dendrobium planted on the volcanic stone. A booster pump was used to increase the water flow, so that the water could collide with the refracting nozzle at high speed and atomize to form a circular water mist, which fell evenly and naturally on the surface of the volcanic stone and dendrobium. This application is to solve the existing dendrobium watering method in the water pipe frame installation is not easy, and the need to constantly adjust the height of the water pipe frame, cumbersome operation, at the same time, need to always adjust the water pressure of the nozzle, to avoid water momentum damage to dendrobium technical problems.

### ILLUSTRATION OF THE INVENTION

In order to more clearly explains application implementation example of the technical scheme, the following will need to use in the implementation of case description were illustrated introduce simply, clearly, described below the appended drawings is just this application in some cases, for the field common technical personnel, can also according to the appended drawings for other appended drawings.

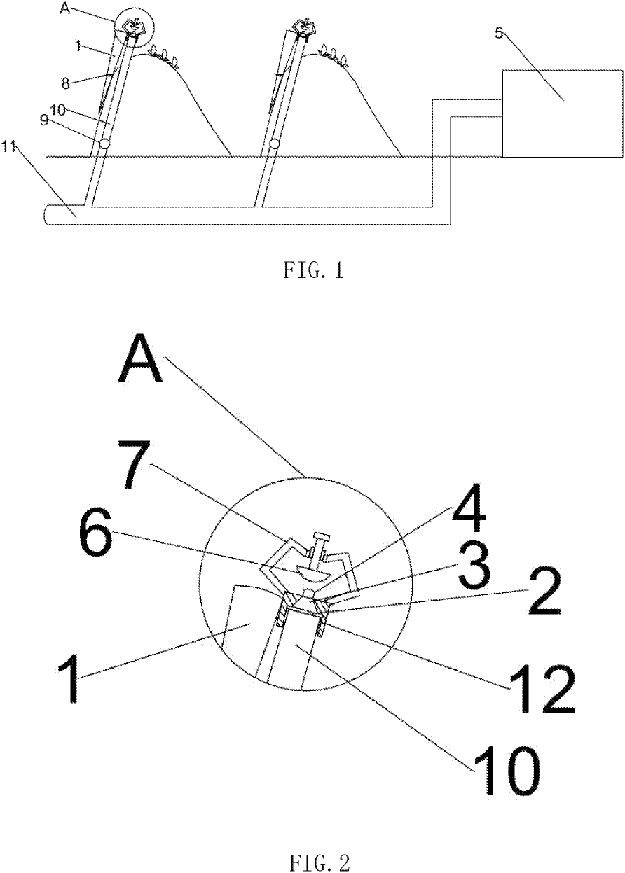

FIG. 1 is a schematic diagram of dendrobium watering method and system structure provided in this application example;

FIG. 2 is the schematic diagram of the enlarged structure at A in FIG. 1.

THE ATTACHED DRAWINGS ARE MARKED AS FOLLOWS

| | | | | | |
|---|---|---|---|---|---|
| 1, | insert rod; | 2, | connecting part; | 3, | water outlet; |
| 4, | nozzle; | 5, | reservoir; | 6, | refracting nozzle; |
| 7, | bracket; | 8, | line code; | 9, | booster pump; |
| 10, | water distribution pipe; | 11 | the main water pipe; | 12, | water distribution pipe joint. |

### DETAILED DESCRIPTION OF EXEMPLARY EMBODIMENTS

In order to make the personnel in the technical field better understand the application scheme, the technical scheme in the application embodiment will be described clearly and completely in the following combination with the attached drawings in the application embodiment. Obviously, the described embodiments are only part of the application embodiment, not all embodiments. Based on the embodiments in this application, all other embodiments obtained by ordinary technical personnel in this field without making creative work are covered by this application.

In the description of this application example, to be sure, the term “center”, “up” and “down”, “left”, “right” and “vertical”, “level”, “inside” and “outside” indicates a location or position relations based on the location or position shown in the appended drawings, only is to facilitate the description in this application example and simplified description, Devices or components other than those indicated or implied must have, be constructed and operated in a particular orientation and shall not be construed as a limitation of this applied embodiment. In addition, the terms “first”, “second” and “third” are used for descriptive purposes only and are not to be understood to indicate or imply relative importance.

In the description of this application embodiment, it should be noted that, unless otherwise expressly specified and qualified, the terms “installation”, “connection” and “connection” shall be broadly understood, for example, a fixed connection, a detachable connection, or an integrated connection; It can be mechanical or electrical; It can be directly connected or indirectly connected through an intermediary. It can be connected within two components. For ordinary technical personnel in this field, the specific meanings of the above terms in this application embodiment can be understood on a case-by-case basis.

### Implementation Example 1

For ease of understanding, please refer to FIG. 1, an embodiment of a dendrobium watering method provided in this application, including:

Step 101: Select a fixed line code 8 on the volcanic rock slope 15-25 cm from the top.

It should be noted that the position of line code 8 was selected on the surface of the upper part of the volcanic stone, and a gentle position was selected on the contact surface between line code 8 and the volcanic stone, so that line code 8 could be fixed more stably. At the same time, when selecting the position of line code 8, we should consider the position of small protrusions in the upper and lower positions of line code 8, so as to avoid the protrusions on the volcanic rock affecting the placement of the ground injection rod.

Step 102: Use line code 8 with hard cement nails to fix the ground jet rod at the position of fixed line code 8. The G-shaped nozzle of the ground jet rod is higher than the top of the volcanic rock. The ground jet rod is connected to reservoir 5 through the booster pump 9.

To be sure, a ground spray rod can be fixed using multiple line code 8, use a hammer to hard masonry nail through the line code 8, line code 8 together with a line of code on the volcano, nozzle position higher than the top of the volcano are better able to make the scope of the nozzle spray water covers the whole volcano, so a volcano on the different position can be planted more than caulis dendrobium, To meet the needs of mass production and space saving.

Step 103: control the pressure of booster pump 9 to increase to 2-5 kpa so that the G-shaped nozzle of the ground injection rod can spray circular water mist to water dendrobium on the volcanic stone.

To be sure, booster pump 9 improve hydraulic booster pump, on the one hand, the reservoir 5 the G-shaped nozzle of spray pump water to the ground rod in the shape of nozzle to irrigation of caulis dendrobium on the volcano, on the other hand, in order to better improve water flow through the G shape of nozzle flow into water mist, atomized spray water after range become more wide, and reduce the water pressure, water mist with natural gravity fall on caulis dendrobium, Avoid damage caused by excessive water pressure on dendrobium itself, especially in the growing period of dendrobium leaves and roots are fragile, more attention should be paid to water pressure.

This application implementation case provides a method of caulis dendrobium watered by way of imitation of wild cultivation of caulis dendrobium on volcano, cant volcano in the upper part of chosen to the location of the fixed line size 8, among them, keep the ground lance nozzle position higher than the top of the volcano, in order to make sure the jet of water evenly in the entire history of the volcano. The line code 8 was fixed on the volcanic stone with hard cement nails, and then the ground insert spray rod was inserted into the jack of the line code 8 for fixing, so as to avoid the ground insert spray rod shaking and falling on the ground in the process of watering. The dendrobium planted on the volcanic stone could not be continued watering. The booster pump 9 was used to increase the water flow, so that the water could impact the refraction nozzle 6 at high speed and atomize to form circular water mist, which fell evenly and naturally on the surface of the volcanic stone and dendrobium. This application is to solve the existing dendrobium watering method in the water pipe frame installation is not easy, and the need to constantly adjust the height of the water pipe frame, cumbersome operation, at the same time, need to always adjust the water pressure of the nozzle, to avoid water momentum damage to dendrobium technical problems.

### Implementation Example 2

As a further improvement of embodiment 1, the dendrobium watering method in this applied embodiment includes the following steps:

Step 201: Select a fixed line code 20 cm from the top of the volcanic rock slope.

It should be noted that the height of the ground injection rod is generally about 60 cm. The fixed position of line code 8 was selected at the top of the volcanic stone along the inclined plane distance of 20 cm, and then the ground injection rod was inserted into the jack of line code 8. The nozzle position of the ground injection rod could be higher than the top of the volcanic stone, but not too high. As a result, when the water mist fell naturally, it deviated from the volcanic stone under the action of the wind, and the water mist could not fall evenly on the surface of the volcanic stone.

Step 202: Use line code 8 with hard cement nails to fix the ground jet rod at the position of line code 8. The G-shaped nozzle of the ground jet rod is higher than the top of the volcanic rock. The ground jet rod is connected to reservoir 5 by booster pump 9.

It should be noted that G-shaped nozzle includes nozzle, refraction nozzle 6 and bracket. Refraction nozzle 6 is installed directly above the nozzle through the support. After the water pressure of booster pump 9 increases to 2-5 kpa, water column of high velocity is sprayed through the nozzle, and the water column is dispersed on refraction nozzle 6 to form circular water mist.

Step 203: Control the pressure of booster pump 9 to 2-5 kpa to make the G-shaped nozzle of the ground injection rod spray circular water mist to water dendrobium on the volcanic rock.

### Implementation Example 3

As a further improvement of embodiment 1, the dendrobium watering method in this applied embodiment includes the following steps:

Step 301: Select a fixed line code 8 15-25 cm above the top of the volcanic rock slope.

Step 302: Drill a small hole in the position of the fixed line code 8 with a hammer drill, insert the expansion rubber particles, insert the ground jet rod into the line code 8 jack, and fix the line code 8 on the expansion rubber particles with screws. Among them, the G-shaped nozzle of the ground injection rod is higher than the top of the volcanic stone, and the ground injection rod is connected with the reservoir 5 through the booster pump 9.

To be sure, the use of percussion drill in the volcano cant drill a small hole, into the expansion of colloidal particles, line code 8 jack plug to spray rod inserted into the line of code, and then screwed a line code 8 on the expansion colloidal particles with the line code, this approach is used to replace the hammer percussion device, to avoid the big hammer percussion lava-rock damage caused by improper hard problem, at the same time this approach saves time and effort.

Step 303: Control the pressure of booster pump 9 to increase to 2-5 kpa so that the G-shaped nozzle of the ground injection rod can spray circular water mist to water dendrobium on the volcanic rock.

### Implementation Example 4

As a further improvement of embodiment 1, the dendrobium watering method in this applied embodiment includes the following steps:

Step 401: Select a fixed line code 8 15-25 cm above the top of the volcanic rock slope.

Step 402: Use line code 8 with hard cement nails to fix the ground jet rod at the position of line code 8. The G-shaped nozzle of the ground jet rod is higher than the top of the volcanic rock. The ground jet rod is connected to reservoir 5 by booster pump 9.

Step 403: When the humidity in the hemispherical area with a radius of 1 m and a volcanic rock as the center was lower than the preset threshold, the pressure of the booster pump 9 was controlled to increase to 2-5 kpa so that the G-shaped nozzle of the ground jet rod sprayed circular water mist to water the Dendrobium on the volcanic rock.

It should be noted that the wireless humidity sensor is preferred in this example to avoid risks caused by circuit leakage. Humidity sensors connected to the controller, the humidity sensor for, centered on lava-rock hemisphere of radius of 1 m area of humidity measurement, the humidity signal transmission to controller, when the humidity is lower than the threshold set by the controller control booster pump 9 water pressure increase to 2-5 kpa makes ground lance G-shaped nozzle jet circle water mist, Watering dendrobium on volcanic rocks; When the humidity is higher than a certain value, the controller closes the solenoid valve switch, stops the booster pump 9, and the watering stops. There is no need to spend manpower to start the watering device to realize automatic watering, and it also avoids the occurrence of water shortage caused by forgetting to start the watering device when planting personnel are busy.

### The Implementation of Case 5

As a further improvement of embodiment 1, the dendrobium watering method in this applied embodiment includes the following steps:

Step 501: Select a fixed line code 8 15-25 cm above the top of the volcanic rock slope.

Step 502: Use line code 8 with hard cement nails to fix the ground jet rod at the position of fixed line code 8. The G-shaped nozzle of the ground jet rod is higher than the top of the volcanic rock. The ground jet rod is connected to reservoir 5 by booster pump 9.

Step 503: in a volcano as the center of the circle, the hemisphere of radius of 1 m area when the humidity is lower than the preset threshold, according to a preset amount of moisture and water table to determine target spraying quantity, control booster pump 9 water pressure increase to 2-5 kpa makes ground lance G-shaped of nozzle jet circle water mist, spray rod is inserted in to the actual amount reach the target amount of spray water, Control booster pump 9 to stop working.

It should be noted that the humidity of the area with a radius of 1 meter away from the volcanic rock is detected. Different stages of dendrobium growth need different amounts of water spraying. If the amount of water spraying is too much, dendrobium will appear retting, and if the amount of water spraying is too little, dendrobium will wither. The humidity threshold was set according to the amount of water spraying in the growth stage of Dendrobium to automatically provide enough water for the healthy growth of dendrobium.

on the other hand, this application also provides a dendrobium watering system of the implementation of the cases, including reservoir 5, the main water pipe 11, water distribution pipe 10, booster pump 9 and spray rod and controller, reservoir 5 connecting the main water pipe 11, on the main water pipe 11 is equipped with the booster pump 9 and water distribution pipe 10, booster pump 9 inlet connected to the reservoir 5, water distribution pipe 10 is connected with the outlet of booster pump 9, water distribution pipe 10 is connected with the ground injection rod, booster pump 9 is connected with the controller.

The main water pipe 11 is distributed with evenly spaced water distribution pipe 10, each water distribution pipe 10 extended out of the soil to connect the ground spray rod to water each dendrobium planted on the volcanic rock, meeting the demand of mass production of dendrobium, is beneficial to the industrial planting development of dendrobium.

It should be noted that the booster pump 9 is preferably set on the water distribution pipe 10 to increase the water pressure to 2-5 kpa to increase the water flow. The booster pump 9 is set on the water distribution pipe 10 to ensure sufficient water pressure in each water distribution pipe 10. If the booster pump 9 is set on the main water transmission pipe 11, the booster pump 9 may be damaged and the whole watering device of dendrobium planting production line stops working, which greatly affects the production of dendrobium. If the number of water pipes 10 is too large, the water pressure in each pipe 10 is insufficient, and it is difficult to spray dendrobium into water mist. A humidity sensor can also be provided on the volcanic rock in an embodiment. The booster pump 9 and the humidity sensor are connected to the controller. The humidity sensor detected the humidity in the hemispherical area with the volcanic stone as the center and a radius of 1 meter, and sent the humidity to the controller. The controller controlled the pressure of booster pump 9 to increase to 2-5 kpa, so that the G-shaped nozzle of the ground injection rod sprayed circular water mist and watered the dendrobium on the volcanic stone.

This application implementation case provides a kind of dendrobium watering system, by way of imitation of wild cultivation of caulis dendrobium on volcano, cant volcano in the upper part of chosen to the location of the fixed line code 8, among them, keep the ground lance nozzle position higher than the top of the volcano, in order to make sure the jet of water evenly in the entire history of the volcano. The line code 8 was fixed on the volcanic stone with hard cement nails, and then the ground insert spray rod was inserted into the jack of the line code 8 for fixing, so as to avoid the ground insert spray rod shaking and falling on the ground in the process of watering. The Dendrobium planted on the volcanic stone could not be continued watering. The booster pump 9 was used to increase the water flow, so that the water could impact the refraction nozzle 6 at high speed and atomize to form circular water mist, which fell evenly and naturally on the surface of the volcanic stone and dendrobium. This application is to solve the existing dendrobium watering method in the water pipe frame installation is not easy, and the need to constantly adjust the height of the water pipe frame, cumbersome operation, at the same time, need to always adjust the water pressure of the nozzle, to avoid water momentum damage to dendrobium technical problems.

In order to facilitate understanding, please refer to FIG. 2. The ground spray rod includes insert rod 1, water distribution pipe 10, water distribution pipe joint 12, nozzle 4, refraction nozzle 6 and bracket 7. Water distribution pipe joint 12 is fixed on the top of insert rod 1, insert rod 1 is an inverted conical rod; Water distribution pipe joint 12 is provided with a connecting part 2 and water outlet part 3, water distribution pipe 10 is connected with the water distribution pipe joint 12 through the connecting part 2, water outlet part 3 is connected with the connecting part 2; Nozzle 4 is arranged on the top of water outlet 3, connected to water outlet 3, r is installed on the top of nozzle 4 through bracket 7.

The outer diameter of insert rod 1 gradually decreases from top to bottom, and the outer diameter of the middle and upper part is larger than the size of large line code 8, so that insert rod 1 can adapt to various types of line code 8. In order to achieve better fixing effect and meet the demand of Angle adjustment of insert rod 1, a variety of different types of line code 8 combination can be used to fix insert rod 1. The connecting part 2 is a threaded hole for screwing the water distribution pipe 10 with threads on the top. A filter layer is arranged between the connecting part 2 and the water outlet part 3 to filter impurities in the water, and it is detachable for easy replacement at any time. The water outlet 3 is in the shape of inverted bell mouth, which concentrates water into nozzle 4 while strengthening the water pressure. Nozzle 4 is in the shape of straight tube, which is used to spray water column to better atomize water mist. The refracting nozzle 6 above the nozzle 4 is a solid half sphere, which is made of stainless steel to improve its service life. The solid sphere makes the refracting nozzle 6 have enough strength to collide with the water column with high velocity without deformation.

The booster pump 9 increases the water pressure to 2-5 kpa so that the water flow in the branch pipe 10 increases. The water flows through the connecting part 2 and the filter layer. The inverted bell shaped water outlet part 3 can speed up the flow rate of water and increase the jet pressure. Because refracting nozzle 6 is located directly above nozzle 4, it collides with water column with high velocity to form circular water mist.

As mentioned above, the above embodiments are only used to illustrate the technical scheme of this application, rather than to restrict it; Notwithstanding the detailed description of this application with reference to the foregoing embodiments, ordinary technical personnel in the field shall understand that they may still modify the technical solutions recorded in the foregoing embodiments or make equivalent substitutions for some of their technical features; Such modification or substitution shall not separate the essence of the corresponding technical solution from the spirit and scope of the technical solution of each embodiment of this application.

1. A dendrobium watering method, which is characterized in that the dendrobium watering method comprises: a fixed line code was selected 15-25 cm from the top of the volcanic stone slope; the line code with hard cement nails is used to fix the ground jet rod at the position of the fixed line code, wherein, the G-shaped nozzle of the ground jet rod is higher than the volcanic stone top, and the ground jet rod is connected with the reservoir through the booster pump; the pressure of the booster pump was controlled to increase to 2-5 kpa, so that the G-shaped nozzle of the ground injection rod sprayed circular water mist and watered the dendrobium on the volcanic stone.

2. The dendrobium watering method mentioned according to in claim 1, wherein that the position of the fixed line code is 20 cm from the top of the volcanic stone slope.

3. The dendrobium watering method mentioned according to in claim 1, wherein the pressure of the booster pump was controlled to increase to 2-5 kpa, so that the G-shaped nozzle of the ground injection rod sprayed circular water mist to irrigate dendrobium on the volcanic stone, including: when the humidity in the hemispherical area with a radius of 1 m and a volcanic stone as the center was lower than the preset threshold, the pressure of the control booster pump was increased to 2-5 kpa, so that the G-shaped nozzle of the ground injection rod sprayed circular water mist and watered the dendrobium on the volcanic stone.

4. The dendrobium watering method mentioned according to in claim 3, wherein the pressure of the booster pump was controlled to increase to 2-5 kpa to make the G-shaped nozzle of the ground injection rod spray circular water mist and water the dendrobium on the volcanic stone, including: when the humidity in the hemisphere area with the volcanic stone as the center and the radius of 1 meter is lower than the preset threshold, the target water spraying amount is determined according to the preset humidity and water spraying volume comparison table, and the water pressure of the booster pump is controlled to increase to 2-5 kpa to make the G-shaped nozzle of the ground injection rod spray circular water mist, the booster pump is controlled to stop working after the actual water spraying amount of the ground insert spray rod reaches the target water spraying amount.

5. The dendrobium watering method mentioned according to in claim 1, wherein the G-shaped nozzle comprises a nozzle, a refracting nozzle and a bracket; the refracting nozzle through the bracket is installed above the nozzle, the pressure of the booster pump to 2-5 kpa through the nozzle to spray a high velocity of water column, the water column collision to the refracting nozzle dispersed to form a circle of water mist.

6. The dendrobium watering method mentioned according to in claim 1, wherein a line code with hard cement nails is used to fix the ground insert spray rod at the position of the fixed line code, including: use a hammer drill to drill a small hole in the position of the fixed line code, put into the expansion colloidal particles, insert the ground jet rod into the line code jack, and then screw the line code is fixed on the expansion colloidal particles.

7. A invention relates to dendrobium watering system, which is characterized in that comprises a reservoir, a main water pipe, water distribution pipe, booster pump, ground injection rod and controller, the reservoir is connected with the main water pipe, the main water pipe is provided with a booster pump and water distribution pipe, the inlet of the booster pump is connected with the reservoir, the water distribution pipe is connected with the outlet of the booster pump, the water distribution pipe is connected with the ground injection rod, the booster pump is connected with the controller.

8. The invention relates to dendrobium watering system according to claim 7, wherein the ground insert spray rod comprises a insert rod, a water distribution pipe, a water distribution pipe joint, a nozzle, a refracting nozzle and a bracket; the water distribution pipe joint is fixed on the top of the insert rod, the insert rod is an inverted cone rod; the water distribution pipe joint is provided with a connecting part and a water outlet part, the water distribution pipe is connected with the water outlet pipe joint through the connecting part, and the water outlet is connected with the connecting part; the nozzle is arranged on the top of the water outlet, connected to the water outlet, and the refraction nozzle is installed directly above the nozzle through the bracket.

9. The invention relates to dendrobium watering system according to claim 8, wherein a filtering layer is arranged between the connecting part and the water outlet part.

10. The invention relates to dendrobium watering system according to claim 7, wherein also includes humidity sensor; the humidity sensor is connected with the controller; the humidity sensor is used to detect the humidity in the hemispheric area with the volcanic stone as the center and a radius of 1 meter, and sends the humidity to the controller; the controller is used to control the increase of the pressure of the booster pump to 2-5 kpa, so that the G-shaped nozzle of the ground insert spray rod can spray circular water mist, and water the dendrobium on the volcanic stone.
